(19) United States
(12) Patent Application Publication
(10) Pub. No.: US 2006/0267228 A1
(43) Pub. Date: Nov. 30, 2006

(54) Reuse process of plastic material and paper rejected in recycling and its resultant product

(76) Inventors: Ronilso Jose Antunes, Curitiba (BR); Assem Omar Barakat, Curitiba (BR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/384,498

(22) Filed: Mar. 21, 2006

(30) Foreign Application Priority Data
Mar. 21, 2005 (BR) PI 0500824-7

(51) Int. Cl. B29B 17/00

(52) U.S. Cl. 264/37.3

(57) ABSTRACT

A reuse process of several plastic material and papers, and other types of material, such as iron and mud, that were simultaneously rejected in previous conventional recycling performed by a paper industry's hydraulic mixer includes nine phases producing a formed wood substitute product having a homogeneous mass formed by fragments of plastic material and other possible materials, presenting up to 50% of fibers from wood, grinded rice peel, coffee straw, grinded bamboo, coconut peel and other similar fibers.

### CROSS REFERENCE TO RELATED APPLICATIONS

This application claims priority to Brazilian Patent Application PI 0500824-7 filed on Mar. 21, 2005, entitled REUSE PROCESS OF PLASTIC MATERIAL AND PPAER REJECTED IN RECYCLING, AND ITS RESULTANT PRODUCT, the disclosure of the application is incorporated herein by reference in its entirety.

### FIELD OF THE INVENTION

The present invention relates to a reuse process of simultaneously rejected plastic materials and paper in conventional paper recycling performed by paper industries, obtaining a resultant product of good quality that can be used in many ways.

### BACKGROUND OF THE INVENTION

Currently, the paper industries perform recycle of great amounts of after-consumption paper generated by the population, observing that, in Brazil, it is estimated a monthly recycle of more than 550.000 tons of such rejects, that after being discarded by the population, initially go through a collection and although considered as selective, presents an efficiency of approximately 80%. According to the technicians' understanding, specialized in the subject, it is foreseen that to each ton of after-consumption collected paper 200 kilos of several undesirable materials are obtained, among plastics that due to its diversity, vary in compositions and tenors. In this miscellany are notably found PE, PP, PVC, PET, ABS, PA, and other plastic types in smaller volumes. During the paper recycling, such undesirable materials represent loss of productivity, being rejected and consequently becoming environmental waste.

It must be noticed that environmental waste is garbage or material that does not go through any recycling process, which accumulated without a destination and causes possible damages to the environment.

All this undesirable material becomes a problem for paper industries that only use the paper from the recycling.

In the specific case of plastic materials, they can not be recycled by current techniques due to its heterogeneous composition, observing that each thermoplastic group has its own rheologic aspect, having singular process parameters, such as fluidity index, softening temperature, crystallization temperature and others. Thus, by the own characteristic of each thermoplastic group it is impossible the agglutination, extrusion, injection, blow or any other well-known process, due to the simultaneous presence of several thermoplastics groups.

According to technicians' knowledge in the subject, there currently is a process that has the purpose of recovering plastic materials obtained from domestic garbage, which are collected by trash pickers, observing that in this process the final product is obtained from a intrusion technique, which result in low productivity and high cost of the raw material, purchased from the pickers, under the condition of the supply being shorter than the demand.

### SUMMARY OF INVENTION

The reuse process of plastic material and paper rejected during recycling, and its resultant product, object of the current invention, was idealized and conceived in secrecy, in accordance to the requirements of the novelty invention, inventive activity and industrial application, and through the proposed reuse process of rejected plastic material and paper which constitutes the undesirable environmental waste resulted from the conventional paper recycling performed by paper industries and until this moment, without a proper solution by these industries, these rejected material are notably re-used, and the resultant product presents characteristics of being a wood substitute taking on varied forms, being resistant to the bad weather and presenting a low cost.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DETAILED DESCRIPTION OF THE INVENTION

The reuse process of plastic material and paper rejected during recycling, and its resultant product comprises of a first phase that consists of the arrangement of plastic material, paper and other types of rejected material such as iron and mud, resultant from a previous recycling performed by a hydraulic mixer, into a tank of decantation, where the decantation of materials with density higher than 2.5 g/cm³, such as iron and mud, can be observed, and is lately and separately removed from the decantation tank with the use of the iron, and is also observed the suspension of materials such as the plastic material, paper and other types of floating rejected materials with inferior density to 2.5 g/cm³, that are conducted by a water flow to a conveyor belt or a worm screw transporter type, that lead to a mill. The second phase consists of milling, by the aforesaid mill, with concomitant washing of the plastic material, paper, and any other type of floating rejected material that will constitute a predominantly liquid mass with fragments of plastic material and other possible materials, and the solubilization of paper leading the mass to a vertical washer. The third phase consists of washing the mass by centrifugation, in the aforesaid vertical washer, with outflow of the water and the solubilized paper that will be later reused, leading the fragments of plastic material and any other type of material, to a vertical dryer. The fourth phase consists of drying the fragments of plastic material and other possible materials, by centrifugation, aided by a flow of hot air, of the plastic material fragments and other possible materials, in the aforesaid vertical dryer, resulting in supplemental outflow of water residue and solubilized paper, that will be later reused, leading the fragments of plastic material and other possible materials, to a compacting machine. The fifth phase consists of compaction of the fragments of plastic material fragments and other possible materials, directly inside of a container for dry storage, by the aforesaid compacting machine. The sixth phase consists of a later disposition of the non-compacted material volume removed from the container into a feeding funnel equipped with a worm screw that promotes forced feeding to an extruder, sequentially resulting in the compression, plastic coating, degasage, new compression and new plastic coating, then the material is consequently extruded into a pasty form, constituting a homogeneous mass, that simultaneously goes with fibers that can be from wood, grinded rice peel, coffee straw, grinded bamboo, coconut peel and other similar fibers coming from a measurer, and can vary in up to 50% of the final volume of the mass, being leaded to a recipient funnel of a fast mixer. The seventh phase consists of homogenizing, of the extruded material with the fibers by the aforesaid fast mixer, forming a mass that goes to the interior of a warm accumulator. The eighth phase consists of accumulating the mass, inside of the aforesaid warm accumulator, until a pre-established volume is reached, when the warm mass is automatically ejected from the desired mold, which presents an admission valve; and, leading to a ninth phase consisting of compressing the warm mass that will take on the foreseen mold configuration.

It must be observed the object of the present invention allows making varied forms of products, such as: beams, fence stakes, plates similar to chipboards, pallets and others. The proposed process allows paper industries to reduce to zero the waste volume of several plastic materials and papers previously rejected.

The resultant product obtained from the reuse process of plastic material and paper rejected during recycling, presents good chemical and physical resistance and is a notable big-sized ecologically perfect product.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of reuse process of plastic material and paper rejected during recycling, which reuses several plastic material and papers, and other types of material, such as iron and mud, that were simultaneously rejected in previous conventional recycling performed by a paper industry's hydraulic mixer, comprising:
a first step of the arrangement of plastic material, paper and other types of rejected material such as iron and mud, resultant from a previous recycling performed by a hydraulic mixer, into a tank of decantation, where the decantation of materials with density higher than 2.5 g/cm³, such as iron and mud, can be observed, and is subsequently and separately removed from the decantation tank with the use of the iron, and is also observed the suspension of materials such as the plastic material, paper and other types of floating rejected materials with inferior density to 2.5 g/cm³, that are conducted by a water flow to a conveyor belt or a worm screw transporter type, that lead to a mill;
a second step of milling using the mill with concomitant washing of the plastic material, paper, and any other type of floating rejected material that will constitute a predominantly liquid mass with fragments of plastic material and other possible materials, and the solubilization of paper leading the mass to a vertical washer;
a third step of washing the mass by centrifugation, in the vertical washer, with outflow of the water and the solubilized paper that will be later reused, leading the fragments of plastic material and any other type of material, to a vertical dryer;
a fourth step of drying the fragments of plastic material and other possible materials, by centrifugation, aided by a flow of hot air, of the plastic material fragments and other possible materials, in the vertical dryer, resulting in supplemental outflow of water residue and solubilized paper, that will be later reused, leading the fragments of plastic material and other possible materials, to a compacting machine;
a fifth step of compacting the fragments of plastic material fragments and other possible materials, directly inside of a container for dry storage, using the compacting machine;
a sixth step of a later disposition of the non-compacted material volume removed from the container into a feeding funnel equipped with a worm screw that promotes forced feeding to an extruder, sequentially resulting in the compression, plastic coating, degasage, new compression and new plastic coating, then the material is consequently extruded into a pasty form, constituting a homogeneous mass, that simultaneously goes with fibers that can be from wood, grinded rice peel, coffee straw, grinded bamboo, coconut peel and other similar fibers coming from a measurer, and can vary in up to 50% of the final volume of the mass, being leaded to a recipient funnel of a fast mixer;
a seventh step of homogenizing of the extruded material with the fibers by the fast mixer, forming a mass that goes to the interior of a warm accumulator;
a eighth step of accumulating the mass, inside of the warm accumulator, until a pre-established volume is reached, when the warm mass is automatically ejected from an admission valve of the desired mold; and
a ninth step of compressing the warm mass that will take on the foreseen mold configuration.

2. A product resulting from the process of claim 1, wherein the product is a formed wood substitute by having a homogeneous mass formed by fragments of plastic material and other possible materials, presenting up to 50% of fibers from wood, grinded rice peel, coffee straw, grinded bamboo, coconut peel and other similar fibers.
